(19) United States
(12) Patent Application Publication
(10) Pub. No.: US 2026/0311169 A1
(43) Pub. Date: Oct. 8, 2026

(54) CONFIGURABLE AND DYNAMIC SECURE PAPER PAYMENTS

(71) Applicant: Austin Capital Bank SSB, Austin, TX (US)

(72) Inventors: John Erik Beguin, Austin, TX (US); Elena Kraus, Round Rock, TX (US); Daniel Dowayne Schulz Dowayne Schulz, Norwalk, IA (US)

(21) Appl. No.: 19/638,939

(22) Filed: Apr. 3, 2026

Related U.S. Application Data
(60) Provisional application No. 63/783,590, filed on Apr. 4, 2025.

(51) Int. Cl. G06Q 20/38; G06Q 20/10

(52) U.S. Cl. CPC G06Q 20/382; G06Q 20/10

(57) ABSTRACT

Methods, systems, and apparatus, including computer programs encoded on computer storage media, for orchestrating secure paper payment (SPP) phases. One of the methods includes assigning one or more security protocols to one or more SPP phases and executing the phases, including: (i) an SPP creation phase that gate-controls access, receives creation data, and creates the SPP; (ii) an SPP issuance phase that gate-controls access and issues the SPP; (iii) an SPP activate-funds-transfer phase that gate-controls access and transfers funds from an original source of funds account to an SPP payment account; and (iv) an SPP payment-account activation phase that gate-controls access and activates the SPP payment account.

### CROSS REFERENCE TO RELATED APPLICATIONS

This application claims the benefit under 35 U.S.C. § 119(e) of the filing date of U.S. Patent Application No. 63/783,590, for “CONFIGURABLE AND DYNAMIC SECURE PAPER PAYMENTS”, which was filed on Apr. 4, 2025, and which is incorporated here by reference.

### BACKGROUND

This specification relates to paper-based instruments and their electronic analogs used in various payment workflows that involve makers, payees, and financial institutions. In such workflows, instruments may be created, issued, and presented for processing through existing clearing mechanisms.

### SUMMARY

In general, one aspect of the subject matter described in this specification can be embodied in methods that include the actions of assigning one or more security protocols to one or more secure paper payment (SPP) phases; executing the one or more SPP phases comprising: executing an SPP creation phase, wherein the SPP creation phase comprises executing assigned security protocols to access SPP creation, receiving data necessary to create an SPP, and creating the SPP; executing an SPP issuance phase, wherein the SPP issuance phase comprises executing assigned security protocols to access SPP issuance, receiving data to issue an SPP, and issuing the SPP; executing an SPP activate funds transfer phase, wherein the SPP activate funds transfer phase comprises executing assigned security protocols to activate funds transfer and executing funds transfer from an original source of funds account to an SPP payment account; and executing an SPP payment account activation phase, wherein the SPP payment account activation phase comprises executing assigned security protocols to access SPP payment account activation.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, executing the SPP creation phase further comprises: reserving one or more unique routing-transit number and account number combinations for respective one or more transfer accounts that move and hold funds between the original source of funds account and the SPP payment account. In those implementations, executing funds transfer from the original source of funds account to the SPP payment account comprises: creating unique routing-transit number and account number combinations using the reserved unique routing-transit number and account number combinations for the transfer accounts; and using the transfer accounts to move and hold funds between the original source of funds account and the SPP payment account.

Alternatively, in some implementations, executing the SPP creation phase further comprises: reserving or designating one or more unique internal ledger identifiers for respective one or more transfer accounts implemented as system-based platform ledger accounts or subaccounts that move and hold funds between the original source of funds account and the SPP payment account, without requiring routing-transit numbers or externally addressable account numbers. In those implementation, executing funds transfer from the original source of funds account to the SPP payment account can comprise: creating, instantiating, or activating the transfer accounts using the reserved unique internal ledger identifiers; and using the transfer accounts to move and hold funds between the original source of funds account and the SPP payment account, including, in some cases, by executing on-ledger postings and, when interfacing with an external payment or funds transfer system, associating the on-ledger transfer accounts with one or more externally addressable settlement accounts.

In some implementations, executing the sequence of one or more SPP phases further comprises: executing an SPP accord phase, wherein the SPP accord phase comprises executing assigned security protocols, presenting a condition to a payee as an offer to resolve a dispute, and receiving acceptance of the condition from the payee.

In some implementations, the SPP accord phase requires validation of a digital signature over the accord terms before funds transfer activation proceeds.

In some implementations, executing the sequence of one or more SPP phases further comprises: executing an SPP user-defined-phase-creation phase that comprises: executing assigned security protocols; receiving user-specified parameters or requirements for one or more user-defined phases; and creating one or more user-defined phases; and executing the user-defined phases.

In some implementations, at least one of the one or more user-defined phases comprises obtaining a cryptographically authenticated approval from a third-party entity to enable the SPP payment account activation phase.

In some implementations, at least one security protocol executed in at least one SPP phase causes a change in funds availability type of at least one of the original source of funds account, one or more transfer accounts, the SPP payment account, or any combination of these accounts.

In some implementations, assigning the one or more security protocols to one or more SPP phases comprises selecting at least one security protocol based on a risk profile associated with at least one of: a user, a device, a transaction, a network, an execution environment, a geographic context, or any combination of these, used to access or execute at least one of the one or more SPP phases.

In some implementations, in response to detecting access from a first device lacking a trusted hardware authenticator, assigning the one or more security protocols to one or more SPP phases comprises requiring a second-device out-of-band authentication prior to the SPP payment account activation phase.

In some implementations, assigning the one or more security protocols to one or more SPP phases comprises processing one or more SPP transaction features using a machine-learning model configured to evaluate the one or more SPP transaction features and, based on the evaluation, automatically select the one or more security protocols for assignment to the one or more SPP phases.

In some implementations, the SPP payment account activation phase comprises initiating a persistent security measure enforcing that post-activation debits to the SPP payment account are authorized only in an amount exactly equal to a stored SPP amount of the SPP.

In some implementations, at least one of a routing-transit number, an account number, and a check number for the SPP is randomly generated.

In some implementations, the SPP payment account is created prior to activation and remains non-operational until all activation-phase security protocols succeed.

In some implementations, the SPP issuance phase requires authenticated approvals from at least two distinct user identities prior to issuing the SPP.

In some implementations, the action further includes providing, to a verifier, an interface that returns current SPP validity, activation status, and funds-type characterization in response to verifier credentials.

In some implementations, failure in a first security protocol triggers assignment of an enhanced second set of security protocols for at least one subsequent SPP phase.

In some implementations, the actions further include authorizing, upon satisfaction of all the assigned one or more security protocols to the one or more SPP phases, a debit from the SPP payment account and a corresponding credit to a payee account via a payment processing system.

In some implementations, the actions further include in response to a failure of at least one of the assigned security protocols in any SPP phase, canceling the SPP and preventing processing of the SPP through a payment processing system.

The subject matter described in this specification can be implemented in various implementations and may result in one or more of the following advantages.

In the field of data security for payment processing, existing paper checks and e-checks expose static banking identifiers on instruments, rely on delayed, post-presentment controls, and lack protocol-enforced activation, which creates opportunities for check washing, counterfeiting, unauthorized ACH debits, identifier harvesting, and premature processing prior to validation; moreover, existing payment systems generally do not provide risk-adaptive, phase-specific security orchestration while remaining interoperable with existing clearing networks, leading to both security vulnerabilities and network inefficiencies.

In addition, conventional paper payment vehicles are generally static in that instrument characteristics, funds characterization, and funds availability are typically fixed at or before issuance and are not adaptively controlled after issuance. In contrast, the techniques described in this specification enable secure paper payment to remain dynamic after issuance (e.g., by permitting activation requirements, funds-availability conditions, verification requirements to be defined, updated, enforces, or changes across secure paper payment phases prior to processing the payment to completion).

This specification describes techniques that can address the aforementioned challenges. That is, the described techniques include assigning one or more security protocols to one or more secure paper payment (SPP) phases and then executing those SPP phases, including (1) an SPP creation phase that gates access, accepts creation data, and creates the SPP; (2) an SPP issuance phase that gates access and issues the SPP; (3) an SPP activate funds transfer phase that gates access and moves funds from an original source of funds account to an SPP payment account (optionally via internal transfer accounts); and (4) an SPP payment account activation phase that gates access and activates the SPP payment account, with activation contingent on satisfying assigned security protocols so that processing can proceed only after security prerequisites are met.

By assigning one or more security protocols to one or more SPP phases, the described techniques implement enforceable, phase-specific data security controls that can be tailored to the operational context and risk of each SPP phase rather than relying on after-the-fact verification.

By executing an SPP creation phase with security protocol-gated access, the described techniques permit reservation or generation of unique routing-account identifiers for SPP and internal transfer accounts without exposing a maker's primary account identifiers, thereby reducing identifier exposure data security risk.

By executing an SPP issuance phase with protocol-gated access, the described techniques separate delivery of the payment vehicle from access to live funds, mitigating interception and alteration risks while supporting paper or digital issuance paths.

By executing an SPP activate funds transfer phase with protocol-gated access, the described techniques stage and hold funds (e.g., in transfer accounts created from previously reserved identifiers) so that funds can be characterized or held under conditions prior to activation while remaining isolated from the maker's source account, reducing the window for unauthorized debits.

By executing an SPP payment account activation phase with protocol-gated access, the described techniques keep the SPP payment account non-operational until SPP payment account activation phase security protocol prerequisites are satisfied and can initiate persistent measures, such as exact-amount-only debits, that continue to protect the SPP payment account after activation, thereby improving post-activation data security.

By reserving and later creating transfer accounts from unique routing-account identifiers and/or from internally defined account identifiers for on-ledger transfers, the described techniques isolate funds movement from the maker's source account and enable conditional staging of funds prior to activation, strengthening data security during transit while preserving compatibility with conventional clearing.

By incorporating an optional SPP accord phase with authenticated acceptance (and, in some cases, validated digital signatures), the described techniques bind activation to verified consent and block unauthorized processing until conditions are met.

By enabling user-defined phases, including phases that require cryptographically authenticated approvals from third parties such as inspectors, escrow agents, or transfer agents, the described techniques allow domain-specific data security gates to be embedded into the same controlled pipeline without modifying clearing rails.

By allowing security protocols to dynamically change funds-availability type across the original source of funds account, transfer accounts, and the SPP payment account, the described techniques programmatically convert available funds to good funds (or vice versa) in response to protocol outcomes, improving settlement assurance without re-issuing the instrument.

By selecting protocols based on device risk and optionally using a machine-learning model trained on device and SPP transaction features, the described techniques adapt authentication cost to real-time posture (for example, requiring second-device out-of-band approvals when a trusted hardware authenticator is absent), thereby reducing false acceptance while minimizing friction in a data-secure manner.

By initiating an exact-amount-only persistent measure at SPP payment account activation, the described techniques prevent off-amount debit attempts even after the SPP payment account is active and funded, improving integrity of downstream processing.

By randomizing routing, account, or check numbers, the described techniques reduce predictability and identifier-enumeration risks on instruments and in digital exchanges.

By creating the SPP payment account prior to activation and keeping it non-operational until security protocol success, the described techniques eliminate timing windows exploited by fraud and reduce reliance on stop-payment actions.

By requiring dual authenticated approvals for issuance, the described techniques mitigate insider and social-engineering risks at the issuance step.

By providing a credential-gated verifier interface that returns SPP validity, activation status, and funds-type characterization to authorized verifiers, the described techniques support real-time confirmation prior to presentment, enhancing operational data security for deposit-taking institutions.

By escalating to an enhanced set of protocols upon a first-protocol failure, the described techniques implement a waterfall of controls that improves the data security of downstream phases against active threats.

By authorizing debit from the SPP payment account and a corresponding credit to a payee account only after satisfaction of all assigned security protocols, the described techniques bind settlement authorization to verified completion of security gates and prevent premature or unauthorized processing

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example secure payment system.

FIG. 2 is a swimlane diagram of an example process for executing a secure paper payment (SPP) between a maker and payee.

FIG. 3 is a flow diagram of an example process for orchestrating secure paper payment phases.

### DETAILED DESCRIPTION

This specification relates to methods and systems for enhanced secure payments using user-customizable security protocols for protecting the transactions necessary to execute the payments.

As one example, the payment may be the financial transactions and associated requests between a maker and a payee using their respective financial accounts.

This specification describes a system implemented as computer programs on one or more computers in one or more locations that executes a secure paper payment between a maker and payee as a sequence of secure payment phases that (i) enables a user (e.g., a maker) to assign security protocols to phases of the secure paper payment, (ii) allows the delivery of the payment vehicle to be separated from the delivery of the funds for the payment, (iii) enables a user to establish the type of funds availability (e.g., available funds, certified funds, cashier check funds, bank funds, etc.), and optionally dynamically change the type of funds availability, and (iv) enables a user (e.g., a payee recipient) to determine if a check is valid (e.g., by ensuring that the funds, the payment instrument, or both are legitimate, to verify the type of available funds, etc.).

That is, the system assigns one or more security protocols to one or more secure paper payments (SPP) phases, such as assigning an SPP phase the use of multi-factor authentication, encryption, biometric authentication, and so on, with further details of security protocols provided below. The system then executes a sequence of one or more SPP phases along with the respective assigned security protocols. When the system executes the one or more SPP phases, they may be executed one after another, in parallel, or in any other defined order (including, e.g., combinations of parallel and one after another), as defined by a user or the system. In some instances, the phases may be executed in a dynamic order based on interactions and specifics in a particular interaction or set of interactions according to a set of defined rules and processes. As a result of completing all the SPP phases and passing all assigned security protocols, the system enables SPP payment from an SPP payment account.

In some implementations, the payment from the SPP payment account includes a transfer from an original source of funds account to the SPP payment account using one or more internal funds transfer accounts to move and hold funds between the original source of funds account and the SPP payment account.

Particular embodiments of the subject matter described in this specification can be implemented so as to realize one or more of the following advantages.

Traditional paper check or e-check forms of payment are static, rigid, and fraught with security issues, facing significant challenges regarding operational efficiency and security.

Today, when a paper check is used as a form of payment, it opens up multiple fraud vectors because of the inherent weaknesses in how a paper check works. These include revealing sensitive information to anyone in physical possession of the check (e.g., the legal name of an accountholder, the physical address of accountholder, the identification of the accountholder's bank [routing number], the accountholders account number, the check number, the check issue date, the memo describing what the payment is for, the driver's license number or co-owner of the account information, the nature of the funds available for the check (i.e. is it a personal check, business check, money order, cashier's check, etc.) and so on).

Due to paper check's reliance on easily manipulated paper documents, paper checks can be stolen physically or digitally. Some examples include: a check being ‘washed’ by removing the payees name or amount and inserting a new payee name or amount; a check can be replicated and changing payee and/or amount; using the routing number and account number to create forged/fake checks; debiting a checking account with a debit ACH file request using information taken from a check; and so on.

Similarly, multiple fraud vectors exist for e-checks. The lack of real-time validation of e-checks allows for exploitation and existing security mechanisms often rely on post-transaction analysis, which limits the ability to prevent fraudulent transactions in real-time.

This specification describes a system that enables a new configurable and dynamic ‘secure paper payment’ that is not bound by the limitations and weaknesses of the most common forms of paper payment today (e.g., personal/business commercial checks, money orders, certified checks, and/or cashier's checks).

Digital payment modalities are often the main focus of payment systems, while paper payments are often regarded as static, and of declining relevance. The techniques described in this specification reconfigure paper-based payments to provide a variety of dynamic, programmable, and verifiable capabilities, achieving both characteristics associated with and beyond what digital payment modalities have.

Secure Paper Payments allow the delivery of the payment vehicle, i.e., the ‘check’, to be separated from the delivery of the funds for the payment. This presents a significant advantage over existing paper payments and digital payment methods.

That is, the techniques described allow a maker to create a check (SPP) with a unique account and routing number, thus eliminating the need for the maker to expose their bank account and financial institution routing number on a check.

In some cases, the account and routing number are created at the time the maker creates the SPP. That is, a unique routing and account number and, therefore, an SPP payment account are created for the SPP upon the creation of the SPP.

In other cases, the account and routing number do not exist at the time the maker creates the SPP but instead, when the maker creates the SPP, a unique routing and account number are provisioned (reserved) for the SPP. If the unique routing and account number are provisioned (reserved) for the SPP, then the unique routing and account number and, therefore, the SPP payment account are created at a later time. Generally, for these cases, the SPP payment account (i.e., unique routing and account number) can be created during and as a part of any SPP phase (e.g., during the SPP funds transfer phase, during the SPP payment account activation phase, etc.) and/or as a result of satisfying a corresponding security protocol of any SPP phase. Generally, it is the case that if an SPP payment account is activated, then the SPP payment account is simultaneously or previously created. Also generally, it is the case that if the SPP payment account is funded, then the SPP payment account is simultaneously or previously created.

In some cases, when a user initiates an SPP, the SPP payment account is neither reserved nor created. For example, when a user initiates an SPP that involves 3rd party protocols for funding that are not satisfied, the unique routing and account number is not reserved or created.

In some cases, regardless of whether the reservation or creation of the SPP payment account occurs, internal funds transfer accounts can be reserved or created independently of the SPP payment account reservation or creation.

The SPP payment account must be ‘activated’ for the respective account and routing number to be valid. When an SPP payment account is ‘created’ the necessary information (i.e., a unique routing and account number) has been established in the system. However, the creation of the SPP payment account does not necessarily mean the SPP payment account is fully operational. The term ‘activated’ refers to enabling the SPP payment account to be fully operational (i.e., enabling the SPP payment account to fully process transactions, access funds, etc.).

In order for an SPP payment account to become ‘activated’ all relevant SPP phases and security protocols must be successfully completed.

For example, to activate an SPP payment account, a requirement can be that the SPP account activation phase be successfully completed (i.e., the SPP payment account activation phase must successfully complete all associated security protocols) for the SPP payment account to be activated. Further details of the SPP payment account activation phase are described below.

As another example, to activate an SPP payment account, a requirement can be successfully completing a security protocol that includes the payee agreeing to an accord and satisfaction requirement/provision for the payment.

As another example, to activate an SPP payment account, a requirement can be successfully completing a security protocol that includes verifying that the SPP payment account has previously been created.

As another example, to activate an SPP payment account, a requirement can be successfully completing a security protocol that includes verifying that the SPP payment account funds availability has been defined.

As another example, to activate an SPP payment account, a requirement can be successfully completing a security protocol that includes verifying the funds for the payment are accessible in whole or in part for the payment.

As another example, to activate an SPP payment account, a requirement can be successfully completing a security protocol that includes verifying that payment processing can be initiated for the SPP payment in whole or in part by a payment system or network such as a check clearing network (clearing house) or ACH conversion processing network.

In some cases, the SPP payment account is created upon activation (e.g., the SPP account is created during the SPP payment account activation phase). But in other cases, the SPP payment account has been previously created before activation (e.g., as a result of satisfying an earlier security protocol). That is, the activation of an SPP payment account is separate from its creation.

The following is an example of an SPP payment that includes SPP payment features and the SPP payment account being created prior to activation. A payor initiates an SPP to buy a car from an online marketplace. Then, the payor funds an account with certified good funds, which the payee can verify. Next, the payor provides the payment to the payee. After which, the SPP payment account can be created with funds available, but not activated. The payor includes in the SPP payment account activation requirements, as security protocols, that inspection of the vehicle by a certified third-party inspector passes, and that the vehicle has a clean title (i.e., the vehicle's title is clear, with no issues affecting ownership). Additionally, the requirements for activation can include security protocols that require identity verification of the payee and/or identity verification of the any other party or individual involved in activation of the payment or movement of funds, including, for example, Know Your Payee (KYP) verification, Know Your Recipient (KYR) verification, or other identity-authentication requirements, for payment to be activated. The payee then receives the SPP payment and delivers the vehicle to a qualified third party inspector. If the payee passes the identity verification, but the vehicle does not pass the inspection (it has major engine damage) and the payee attempts to deposit or process the payment, the payment will be returned by the payment network. The network message can indicate the account exists, but that the account has ‘insufficient funds’ because the account exists, but the funds associated with or held in the account have a HOLD placed on them, making them unavailable for withdrawal for the payment. The funds can be returned to the original source of funds account or continue to be held in the SPP payment account, based on the security protocols and other requirements assigned to the SPP.

As a consequence of the separation of the delivery of the payment vehicle from the delivery of the funds for the payment, funds for an SPP can move separately from the creation and activation of an SPP payment account. Additionally, the funds can be provided in any combination of available funds basis or good funds basis, e.g., funds for an SPP can be on an available basis (equivalent of a personal or business check), good funds maker's funds basis (equivalent of a money order or certified check), good funds financial institution basis (equivalent of a cashier's check) or other funds basis as defined by a user.

The techniques described also allow any user in the secure paper payment ecosystem to define and customize SPP payment account activation and funding criteria. Additionally, the described techniques allow any qualified recipient of a check to verify the validity of the check as well as the availability of funds and nature of the availability, i.e. available or good funds, and a user of the described techniques can define the data and format of data that can be verified by any other user.

Additionally, the techniques described also allow the maker of an SPP to cancel or block a payment process before the SPP payment account is activated or after it is activated but not yet redeemed. For such cases, funds can be returned to the original source of funds account or continue to be held in the SPP payment account, based on the security protocols assigned to the SPP phases.

For example, a maker that sends an SPP for an investment can learn (after the SPP has been created, funded, and activated, but not yet presented for payment) that the investment opportunity may be fraudulent or that the information presented to them may have been potentially misleading. The maker can then cancel, block, or hold the payment until the situation has been resolved to their satisfaction.

An additional advantage of the techniques described is their full interoperability and compatibility with existing and conventional payment systems (i.e., traditional check processing networks and clearing houses, computer-based electronic networks for processing transactions, banking institutions' processing systems, and so on). The complete compatibility with existing and conventional payment system ensures that payments using the described techniques maintain the security of existing and conventional payment processes while further enhancing the security of these payments to an unmatched standard.

Some examples of the described techniques follow.

For example, a mother wants to mail her son a check. She has heard about mail theft and check washing and is nervous about mailing a check, but also knows payment apps are rife with fraud. She can mail (or email) an SPP to her son via USPS. If the check is stolen in the mail, it is worthless to the criminal that stole it. The account number and routing number do not exist and there are no funds available for the SPP or SPP payment account. She mails the SPP. Her son informs her he has received it. She activates the SPP (i.e., activates the SPP payment account). The SPP payment account is created and funds are made available for the account. The son can now deposit/cash the check in any manner he chooses.

As another example, a bank customer presents a high dollar SPP for deposit at a bank. The bank and employee of the bank can register with a network to gain access to validate the check. In this example the teller and their institution have been previously validated by the network. The teller logs into the network and enters the payee and payment information from the SPP. The network returns information verifying the validity of the information entered and the basis for funds availability (example: good funds or available funds). Conversely the network could return a response indicating the information entered is not valid for the SPP. The teller can then proceed with the deposit transaction accordingly.

As another example, a consumer wants to purchase a new car on a Sunday when their bank is closed. They do not know the final purchase price they will pay for the vehicle, but they do know the top end of the range they are willing to pay. Prior to the weekend, the consumer (maker) transfers to a ‘good funds’ account or allocates/locks sufficient funds for the purchase at the maker's bank. The maker's bank approves the creation of an SPP backed by bank funds (a cashier's check equivalent) up to the amount of funds that has been transferred/allocated/locked at the maker's bank. The consumer visits the dealership, selects the vehicle, and negotiates the purchase and price. While sitting at the dealership, the consumer then generates an SPP for the exact amount of the purchase using a mobile device or computer and can either print the SPP at the dealership or send it electronically (example via email, text, Bluetooth, or other electronic means) to a representative of the dealership. The dealership receives the SPP, but before releasing the vehicle to the consumer, wants to be certain the payment is valid and the funds are good. A representative of the dealership logs into the network and enters the information from the SPP. The representative confirms that the payment is valid and that it is backed by good funds from the maker's bank. The purchase is completed, and the dealership releases the vehicle to the consumer.

As another example, for a real estate transaction, currently wire fraud is plaguing the title company industry, with a wire, once the payment is sent, it is too late to verify or correct the recipient. With a Secure Paper Payment an inactive ‘cashier's check’ could be delivered physically or a digital representation of the paper payment could be delivered electronically to a title company backed by maker's Bank good funds. Then, the title company could verify that the check is valid and supported with maker's Bank good funds. The sender (maker) could then verify directly with the title company that the title company has received the payment vehicle before ‘activating the payment’ allowing the recipient title company to deposit and immediately access the funds, or the maker could require the title company to pass a security protocol to access activation of the funds, including due diligence processes (e.g., ‘know your customer’, know your business), or geographic or any other restriction as defined by a Security Measure or the Security Protocol.

While traditional checks are focused on physical security components of the check and securing physical paper check stock, physical security elements for secure paper payments are mostly irrelevant and the SPP may be printed on almost any standard printer compatible paper.

Currently, a user (for example an original payee recipient, a non-bank intermediary recipient, the bank of first deposit, or other third-party) has no means to determine if a check is valid, meaning all information on the check is accurate and unaltered; authentic, meaning it was issued by the maker with legal ownership of the original source of funds for the payment; and/or assess and/or confirm the availability or character of funds that will be used to satisfy the payment.

Current industry offerings that attempt to at least partially address these issues include “Positive pay with payee verification”. Positive pay with payee verification is not triggered until a check is presented to the check maker's bank by a clearing house and funds may have already been debited from the maker's bank and credited to the payee's bank. When presented by the clearing house, the check maker's bank will verify the 1) dollar amount of the check, 2) the account and routing number, 3) check date, and 4) payee name, against a list of checks the maker has provided to the bank as authorized to be paid. Notably, this process occurs with a time delay from the time a check has been presented to a recipient (original or non-bank intermediary) or bank of first deposit, and the check is retroactively returned and a denial of funds to honor the check are sent back to the bank of first deposit after it has already processed the check. The time delay of the positive pay verification may present a vulnerability for the payment system where some or all of the funds may potentially be withdrawn by the payee before verification can occur.

Another current industry offering that attempts to at least partially address these issues includes e-checks. In a slight improvement over positive pay, some e-check offerings allow a user to verify 1) dollar amount of the check, 2) payee, 3) check number, and 4) routing and account number at the time of presentment to a user. Notably these offerings do not provide any insight into the funds availability for the check, type of funds availability (good vs available, and different types of good funds), or character of the payment (e.g. separate property or community property).

This specification describes a system that can enable a user to determine if a check is valid. That is, this specification describes techniques that would allow an approved user, at the time of SPP presentment or at any time during the payment activation process, to verify the activation status of an SPP (e.g., verify active or inactive status of an SPP payment account); identify parties and steps that must be completed, acknowledged, passed, or accepted by each user for an SPP to be successfully activated; identify remaining days until an SPP is cancelled (if applicable); verify the availability of funds for an SPP and the nature of availability (e.g., ‘available funds’, ‘good funds: certified maker funds’, ‘good funds: certified bank funds’, ‘other third-party’ funds, or any other source of funds, for example a sinking fund that can be depleted and/or replenished, etc.); and verify and validate one or more payment instructions (e.g., SPP dollar amount, payee, unique routing number and account number combination for the SPP, SPP ‘check number’ payment number, SPP origination date.

Additionally, a user of the system could configure what another user can view and/or verify for any SPP and can configure the information that is presented to another user during the verification and validation process.

Further details of the SPP phases are described below.

For the purpose of this disclosure, the following terms are defined.

Secure Paper Payment: A secure paper payment (SPP) is a physical check, or digital image or electronic representation of a check. Funds for an SPP can be provided in any combination of an available funds basis or good funds basis. Available funds and good funds can be any combination of maker funds, maker's Bank funds, or any other 3rd party funds.

Maker: A maker is the party originating the SPP. They provide, at a minimum, the payee and amount of the payment, but may enhance an SPP with additional information such as date, payment number, additional notes/memo, or other data.

Payee Recipient: The payee recipient is the original payee of the SPP. Similar to a check, a payee recipient may endorse an SPP to a non-bank intermediary recipient that takes the place of the payee recipient.

Non-Bank Intermediary: A non-bank intermediary is any party that receives an endorsed SPP from a payee recipient and therefore assumes the role of the payee recipient.

Maker's Bank: Similar to the traditional check ecosystem, a maker's Bank is the financial institution where the maker has title to the bank account that will serve as the original source of funds for an SPP.

Bank of First Deposit: Similar to the traditional check ecosystem, the bank of first deposit is the financial institution where an SPP is first presented for deposit.

Clearing House: For the purpose of this application a clearing house is any entity or service that clears check payments and/or provides services related to check clearing, typically as party of a dedicated clearing house, bilateral agreement, or multiparty agreement.

User: A user includes, but is not limited to, a maker, payee recipient, non-bank recipient, maker's bank, bank of first deposit, clearing house, any third-party entity or natural person. users may include, but are not limited to: financial institutions, natural persons, insured financial institutions, uninsured financial service providers, merchants, service providers, technology providers, any government entity, agency, or division of local, state, or federal government.

Phases: Phases are predefined or user-defined steps required to complete an SPP process. Examples of predefined phases include, but are not limited to: SPP creation, SPP issuance, SPP activate funds transfer, SPP payment account activation, SPP activation of user-defined phases. A user-defined phase can be defined by one or more users and can include any user-specified parameter or requirement for an SPP that can be applied to any phase of an SPP or that can define one or more additional phases of an SPP. These phases may be segregated or grouped in any combination or order, including sequentially or non-sequentially.

Further details of the SPP phases are described below.

Security Measures: Security measures refer to any safeguard or protocol specifically designed to protect financial transactions and sensitive payment information from fraud, unauthorized access, or theft. In the case of an SPP, they also include any user defined criteria or requirement that must be accepted and/or passed by another user for the payment to be completed. The outcome of a user attempting to satisfy a security measure can be the security measure has been satisfied, not satisfied, or trigger additional actions and/or conditions that are required to satisfy the security measure. Security Measures can be defined and applied to any phase or parameter of the SPP process.

Some examples of security measures may include, but are not limited to, the following:
user authorization code
device authentication
identity authentication
location/geographic authentication
in-person or physical authentication
knowledge based authentication
biometric authentication
third-party authentication or approval
third-party application access
data-based authentication
specified date for completion or range of dates
device ownership verification
user, device, or network behavior
positive pay for check attributes (including but not limited to amount, date issued, payee, check number, etc.), and
user defined security protocol or phase.

Security Protocol: A security protocol refers to a single, or set of, security measures that must be completed by user(s) to access or initiate a phase.

Risk Profile: A risk profile refers to one or more characteristics, conditions, metadata, items, contextual indicators, historical outcomes, behavioral signals, or any combination of these usable by the system to assess risk associated with access to, execution of, or participation in one or more SPP phases. A risk profile can be associated with any suitable subject relevant to an SPP phase, including, for example, a user, a transaction, a network, an execution environment, a geographic context, or any combination of these.

Further details of security protocols are described below.

Character of Funds: The character of funds is the identification of funds through any of a variety of characterization schemes that a user or the secure paper payment ecosystem may define. For example, based on funds ownership and applicable laws, funds can be identified as separate property, community property, or unclassified/other.

Original Source of Funds Account: The original source of funds account is the maker's original source of funds for an SPP. An SPP may have more than one original source of funds account.

SPP Payment Account: The SPP payment account is a unique routing-transit number & account number assigned to an SPP that can be processed through the existing check processing ecosystem.

Transfer Account: A transfer account (or also known as internal funds transfer account or funds transfer account) is a unique account number that may be internal or a routing/transit number/account number combination for holding or moving funds during any phase of an SPP. That is, in some implementations, the transfer account is an internally defined on-ledger account for which a routing-transit number and account number combination is not required. But, in some other implementations, the transfer account is identified by a routing-transit number and account number combination.

In some implementations, an on-ledger transfer account is identified within the system by a unique internal ledger identifier (e.g., a platform-ledger account identifiers or subaccount identifier). In some implementations, the system associates one or more such on-ledger transfer accounts with one or more externally addressable settlement accounts to enable interfacing with external payment and funds transfer system.

Having defined the terms as used herein, attention is directed back to the initial description of how the system operates.

In particular, the system assigns one or more security protocols to one or more SPP phases.

In some cases, a user configures how the system can assign one or more security protocols, e.g., using an end-user device. In other cases, the system uses maintained data to assign the one or more security protocols.

The system can receive one or more security protocols, e.g., from a user (e.g., a maker or payee) through an end-user device as, for example, user-defined security protocols or selections of pre-defined security protocols. Alternatively, or in addition, the system can also receive one or more security protocols, e.g., from maintained data.

In some cases, the system further assigns security protocols based on a risk profile. The risk profile can be associated with any suitable subject relevant to an SPP phase. For example, the risk profile can be associated with one or more of a user, a device, a transaction, a network, an executing environment, a geographic context, or any combination of these, used to access or execute at least one of the SPP phases.

For example, the system can assign security protocols based on a risk profile associated with a device used to activate an SPP (e.g., the system assigns security protocols in real-time according to the device used to access SPP payment account activation), and the system assigns these security protocols automatically without user input.

The risk profile can include, for example, device identification and metadata. For example, the risk profile for the device can include device type (e.g., laptop, smartphone, smartwatch, and so on), device hardware and software versioning (device model version, operating system version, software version, and so on), device usage (e.g., frequency and pattern of device usage), and so on.

For example, the system can further assign a security protocol to require a user accessing SPP payment account activation from a first device to utilize a second device. For example, when the system detects that a laptop is being used to access SPP payment account activation, the system can require two-factor authentication via, e.g., text on a smartphone device.

As another example, the system can further assign a security protocol based on available security protocols specific to the device. For example, when the system detects the use of a smartphone to access SPP payment account activation, the system can require smartphone biometric authentication, e.g., smartphone facial recognition or smartphone fingerprint reading.

In some cases, the system uses a machine learning model, such as a deep neural network, to process the risk profile of the device and determine the appropriate security protocols to assign to SPP account activation phase.

The system executes a sequence of one or more SPP phases, which includes executing the assigned security protocol(s) to each phase.

The SPP phases can operate independently or interdependently as configured by a user, the system, or both.

The security protocols (and included security measures) can be independently satisfied or required to be successfully completed in a specific order or sequence.

In some cases, security protocols may be waterfalled, so that failure or an indeterminate or defined outcome of a security protocol or suspicious or unexpected activity related to a security protocol or set of security protocols triggers additional enhanced security protocols. For example, if payee and owner of a mobile device do not match, additional security protocols may be required.

In some cases, security protocols can be established to specific payment, flows of funds, and/or industries. For example, security protocols may be defined by: technology provider, financial institution, payee, maker, third-party, amount of payment, industry, specific use cases, real estate transaction, vehicle purchase, insurance reimbursement, hotel reservation, ticket purchase, escrow of funds, etc.

In some cases, a security protocol assigned to an SPP phase can include initiating a persistent security measure that remains in effect beyond the SPP phase of the security protocol. That is, the security protocol assigned to an SPP phase can be to initiate a persistent security measure, and the system considers the security protocol successfully completed after the initiation of the persistent security measure. Yet, the persistent security measure remains in effect beyond the completion of the SPP phase.

For example, the system can assign a security protocol to the SPP payment account activation phase that includes initiating an “exact amount authorization protocol”, where the “exact amount authorization protocol” includes blocking attempts to debit funds from an activated and funded payment account in an amount that does not exactly match the amount of the SPP payment the payment account is intended to transfer. So, after the SPP payment account activation phase has successfully completed all associated security protocols and activated the payment account for the phase, if an attempt to debit funds of an amount that differs from the SPP payment the account is intended to transfer occurs, then the system blocks the funds transfer.

As another example, the system can assign a security protocol to the SPP payment account activation phase that includes initiation a “debit in part or whole protocol”, where the “debit in part or whole protocol” includes the system allowing an activated payment account (i.e., the account activated by the system in response to completing an SPP payment account activation phase) to be debited in whole or in part up to the total amount of funds that is included in the activated account.

Optionally, the “debit in part or whole” protocol can include one or more user or system defined criteria for making funds available in a staged fashion. In other words, the system can make the funds available in stages, where a portion of the total amount of funds is made available based on one or more criteria, followed by additional availability of funds as further conditions are met. The sum of funds available across all stages is the total amount of funds of the SPP so that no subset of stage available funds exceeds the SPP total amount of funds.

As a particular example, the system can assign a ‘debit in part or whole’ protocol to the payment account activation phase where, upon payment account activation, funds are made available on a partial of the total amount. For example, the maker of the SPP can define a condition for making 50% of the funds available to be the payee completing 50% of a project that was ‘paid for’ with the SPP. Then a further condition to making the remaining 50% available defined by the maker can be the payee completing the remaining 50% of the project.

In some cases, a security protocol assigned to an SPP phase can include changing the funds availability type (i.e., dynamically changing the funds availability type) held in one or more accounts (e.g., an original source of funds account, one or more transfer accounts, an SPP payment account, or any combination of these accounts). For example, a security protocol can involve changing the type of available funds in an SPP payment account from ‘available’ to ‘good’ in response to satisfying security measures.

As a particular example, a maker wants to expedite delivery of goods or services subsequent to placing an order and sending an SPP, and the payee requires ‘good funds’ to initiate expedited shipping or delivery of the goods or services. The maker can modify the type of funds availability for the payment vehicle that has already been delivered to the payee, a corresponding security protocol can execute, and, as a consequence of passing the corresponding security protocol, the funds change from ‘available’ to ‘good funds so that the payee will immediately ship or deliver the goods/services.

Further in some cases, one or more phases can each include one or more security protocols that each include changing the funds availability type (i.e., dynamically changing the type of funds across SPP phases in addition to within an SPP phase) held in one or more accounts (e.g., an original source of funds account, one or more transfer accounts, an SPP payment account, or any combination of these accounts).

### SPP Creation Phase

The system executes an SPP creation phase.

The SPP creation phase includes executing assigned security protocols to access SPP creation and then entering the information necessary to generate an SPP, which may include, but is not limited to: payee, amount, date, character of funds, SPP number, payee identifying information, payment memo or note information, and so on.

As described above, in some cases, when the system executes the SPP creation phase, the system creates a unique routing-transit number & account number combination and, therefore, an SPP payment account.

Also as described above, in some other cases, when the system executes the SPP creation phase, the system reserves (i.e., provisions) a unique routing-transit number & account number combination but does not create an SPP payment account.

Generally, the SPP payment account (i.e., unique routing and account number) can be created during and as a part of any SPP phase (e.g., during the SPP funds transfer phase, during the SPP payment account activation phase, etc.) and/or as a result of satisfying a corresponding security protocol of any SPP phase. Generally, if an SPP payment account is activated, then the SPP payment account is simultaneously or previously created. Also generally, if the SPP payment account is funded, then the SPP payment account is simultaneously or previously created. In some implementations, the system also creates one or more unique routing-transit number and account number combinations for internal funds transfer accounts that move and hold funds between an original source of funds account and the SPP payment account.

Alternatively, in some implementations, instead of reserving routing-transit number and account number combinations for the internal funds transfer accounts, the system reserves or otherwise designates one or more unique internal ledger identifiers for respective on-ledger transfer accounts (e.g., platform ledger accounts or subaccounts).

In some other implementations, the system reserves one or more unique routing-transit number and account number combinations for internal funds transfer accounts that move and hold funds between an original source of funds account and the SPP payment account, but the system does not create the internal funds transfer accounts.

Generally, the internal funds transfer account(s) (i.e., unique routing and account number) can be created during and as a part of any SPP phase (e.g., during the SPP funds transfer phase, etc.) and/or as a result of satisfying a corresponding security protocol of any SPP phase. Also generally, if the internal funds transfer account is funded, then the SPP payment account is simultaneously or previously created.

In some cases, the unique routing-transit number and account number combinations are randomized routing-transit number & account number. Further in some cases, optional check number is also randomized.

### SPP Issuance Phase

The system executes an SPP issuance phase.

The SPP issuance phase includes executing assigned security protocols to access SPP issuance and the act of issuing an SPP.

In some cases, the SPP issuance phase may require more than one user, e.g. for a dual signature required SPP.

In some cases, the SPP issuance phase may include determining format e.g. printed paper or digital image.

In some cases, the SPP issuance phase may include determining delivery method and format; e.g. printed physical in-person delivery, mail/delivery service, electronic delivery; i.e. email, text, messaging app, other digital delivery of SPP image and associated content.

In some cases, the SPP issuance phase may include selecting source of funds for SPP.

In some cases, the SPP issuance phase may include defining character and source of funds for SPP, e.g. available funds or good funds and source of funds, i.e. maker, maker's Bank, Third-Party, etc.

In some implementations, components of the SPP creation phase and the SPP issuance phase may be combined or segregated and defined in any grouping(s) or manner by a user.

### SPP Activate Funds Transfer Phase

The system executes an SPP activate funds transfer phase.

The SPP activate funds transfer phase includes executing assigned security protocols to activate funds transfer and moving funds from one account to another account to enable a payment (e.g., from an original source of funds account to the SPP payment account).

In some cases, the original source of funds can be multiple originating accounts.

In some implementations, when the system includes internal funds transfer accounts, the system uses the internal funds transfer accounts to move funds from one account to another account to enable payment. In some implementations, the internal funds transfer accounts are internally defined on-ledger accounts for which a routing-transit number and account number combination is not required.

In such implementations, the system can execute funds movement and holding using on-ledger postings to the on-ledger transfer accounts and can interface with an external payment or funds transfer system via one or more externally addressable settlement accounts associated with the on-ledger transfer accounts.

Further in some implementations, for the system to use the internal funds transfer accounts the system creates unique routing-transit number and account number combinations using the reserved unique routing-transit number and account number combinations for the internal funds transfer accounts if these internal funds transfer accounts are not already created.

Further in some implementations, for the system to transfer funds to the SPP account the system creates a unique routing-transit number and account number combinations using the reserved unique routing-transit number and account number combinations for the SPP payment account if the SPP payment account is not already created.

In some implementations, the system executes an SPP accord phase (i.e., a phase that can execute accord and satisfaction, i.e., a legal principle for resolving disputes by mutual agreement).

The accord phase includes executing assigned security protocols, presenting a condition to a payee as an offer to resolve a dispute between a maker and the payee, and receiving acceptance of the condition from the payee as a condition of the payment.

In some implementations, the system executes an SPP create a user-defined-phase phase.

The SPP create a user-defined-phase phase includes executing assigned security protocols, receiving user specified parameters or requirements for one or more user-defined-phases, creating one or more user-defined-phases, and executing the user-defined-phases.

### SPP Payment Account Activation Phase

The system executes an SPP payment account activation phase.

The SPP payment account activation phase includes executing assigned security protocols to access SPP payment account activation.

In some implementations, during the SPP payment account activation phase, the system creates a unique routing-transit number and account number combinations using the reserved unique routing-transit number and account number combinations for the SPP payment account if the SPP payment account is not already created. For example, upon successfully completing all the security protocols of the SPP payment account activation phase, the system can create the SPP payment account.

An advantage of using the SPP payment account is that a maker's original source of funds account routing-transit number and account number combination are never exposed publicly or to any other party.

If all required security measures and security protocols are not satisfied, the SPP Payment account is never ‘activated’, which eliminates the need for stop payments.

Additionally, the many security protocols can eliminate most risk of check fraud via check washing, forgery, counterfeiting, and ID theft.

The system also offers many unique features through the assignment of custom security protocols and user-defined-phases.

For example, the system can set unique expiration date or ‘payment window’ for each individual payment.

As another example, the user-defined-phase can set custom criteria to activate and/or make funds available for any check (SPP).

As a particular example of a user-defined-phase, a user-defined-phase can be one in which a maker requires a signed lien waiver, a legal document in which a party relinquishes their right to file a lien, prior to the SPP being activated. For example, this user-defined-phase can include a user-defined security protocol that sends an electronic request for a payee to sign and submit a lien wavier, verifies the authenticity of the payee's electronic signature, and only then activates an SPP payment account with funds for the payee to debit.

As another example, the system can require payee recipient to agree to maker terms of payment (for example Accord and Satisfaction) prior to funds being made available to payee Recipient

As another example, the system can require payee recipient agreement and acknowledgement of characterization of funds for payment (for example separate or community property).

As another example, the system can function as an escrow account where a maker has released funds, but all conditions are not yet satisfied for payment activation and for payee to receive funds, e.g., funds are released to payee when an independent, third-party, i.e. escrow officer, inspector, or transfer agent independently determines criteria required for payment have been satisfied.

As another example, the system can enforce dual (or more) approval and/or authentication for payment issuance and/or depositing payment through the security protocols.

### Example Solutions

Some examples of uses of the described techniques to address current issues follow.

Example 1: Current Issue—Theft, alteration, forgery, and counterfeiting of IRS refund checks, including robbing postal service workers to obtain IRS checks.

SPP Solution: The internal revenue service issues a tax refund payment in the form of an SPP.
1. The payment can be physically mailed or electronically delivered as a digital image.
2. The payee of the refund receives the physical paper payment or digital image.
3. The IRS has preestablished a set of security protocols based on the risk of the payment and payee.
   a. In one case, the IRS may require the payee to provide prior years' tax information to activate the payment account and transfer funds to the payment account
   b. In another case, for a larger refund amount, the recipient may be required to log into a secure IRS or affiliated portal and pass an identity and knowledge verification security protocols for the payment account to be activated and funds transferred to the payment account.
4. In either case, if the physical check or digital representation of the check is misappropriated by theft, fraud, or criminal activity during delivery, the physical check or digital image is worthless, because no payment account exists that correlates to the routing number and account number on the check and no funds are available to the criminal because there is no account.

Any qualified recipient of an IRS tax refund check (example retailer or financial institution) would be able to use the Network to verify the validity of the payment and availability of funds. By replacing checks with Secure Paper Payments, the IRS could virtually eliminate counterfeit or forged tax refund checks preventing millions of dollars of losses for banks, CUs, and retail financial service providers, and save millions of hours of time for American taxpayers and IRS employees.

Example 2: Current Issue—An individual wants to send another individual a check. The check can be stolen in transit, the account number and routing number can be used to create unauthorized debits or counterfeit checks, the check can be washed, altered, or presented for payment using a stolen identity.

SPP Solution: An individual wants to send a check to another individual.
1. The sender can either send a physical paper payment (check) or a digital image representation.
2. The recipient receives the paper payment or image
3. The sender confirms receipt of the payment with recipient.
4. The sender activates the check and makes funds available for the Payment Account.
5. The recipient can present the check for deposit or payment.
6. Again, if the physical check or digital representation of the check is misappropriated by theft, fraud, or criminal activity during delivery, the physical check or digital image is worthless, because no payment account exists that correlates to the routing number and account number on the check and no funds are available to the criminal because there is no account.

Example 3: Current Issue-A business wants to pay vendors by check. The check can be stolen in transit, the account number and routing number can be used to create unauthorized debits or counterfeit checks, the check can be washed, altered, or presented for payment using a stolen fraudulent business or individual identification.

SPP Solution: A business pays vendors by check
1. The business sends a physical paper payment (check) or a digital image representation to the vendor
2. The business assigns the vendor a specific security protocol, or set of protocols, to activate and fund the checks it receives from the business
3. The vendor receives the paper payment or digital image.
4. The vendor logs into a designated online portal and successfully completes the security protocol(s).
5. The payment account is created and funds are made available.
6. The vendor can present the check for deposit or payment.

Example 4: Current Issue—A building owner wants to build an addition to their building. The owner wants to make certain the work is completed as agreed prior to payment and the builder wants to be certain they will be paid if they complete the work as agreed. Additionally, all the risks of a business paying a vendor by check are present.

SPP Solution: A building owner wants to build an addition to their current building.
1. The building owner and contractor agree to a contract detailing the project plans and payment schedule in three phases.
2. The contractor wants to know they will get paid if they complete the construction in accordance with the contract and the building owner wants to know the contractor will complete the work according to the contract terms.
3. The building owner and contractor contract with a mutually agreed upon independent construction inspector. The inspector will review the project as it progresses and certify satisfactory completion of the project phases.
4. At contract signing, the building owner issues three separate secure paper payments to the builder.
5. Funds for each payment are moved from the building owner's account to three separate transfer accounts.
6. The builder can verify that each of the checks is backed by ‘good and available funds’.
7. After completing phase one of the project, the builder notifies the inspector.
8. The inspector reviews the work and agrees that the construction is in accordance with the contract. The inspector completes a predefined security protocol.
9. Funds are made available from the first Funds Transfer Account to the first Payment Account and the builder can present the payment for deposit.
10. The process repeats, with the inspector either approving the work as completed, or requiring rework/additional work before completing the security protocol for each project phase.

Example 5: Current Issue—An individual wants to purchase a vehicle. The seller requires a cashier's check (good funds) for the purchase. The final price of the vehicle is unknown until the buyer and seller agree and the purchase takes place on a federal holiday or weekend when financial institutions are closed. The buyer doesn't know what amount to obtain a cashier's check for and may be unable to obtain a cashier's check on the desired date of purchase. The seller doesn't know if the cashier's check is good or counterfeit.

SPP Solution: Vehicle Purchase
1. Prior to meeting the seller, the buyer initiates an SPP including a Funds Transfer Account.
2. Sufficient funds for the purchase are transferred from the Originating Account to the Funds Transfer account.
3. The Buyer's financial institution classifies the funds as ‘good funds’ and they are locked and held for the payment.
4. The buyer and the seller agree on a price for the vehicle and that title is clear and available for transfer.
5. The buyer activates the SPP and either provides the seller with a physical check or digital image of the check.
6. The seller receives the check and verifies that the check is valid and sufficient good funds are available for the payment.
7. Title is transferred and seller can present the check for deposit or payment

Example 6: Current Issue—A company purchases widgets from a supplier. 10% of the widgets are damaged and unusable. The purchaser wants to pay for the good widgets and simultaneously obtain agreement from the supplier that the payment is in full satisfaction of the original purchase agreement.

SPP Solution: Partial Payment with Accord and Satisfaction
1. The buyer issues an SPP to the supplier in an amount sufficient to pay for the 90% of satisfactory quality widgets.
2. The buyer includes a user Defined Phase with a Security Protocol sufficient for the purchaser to legally prove accord and satisfaction if acknowledged and accepted by the supplier.
a. For example: Acceptance of this payment requires supplier to agree that payment is payment in full for purchase agreement XYZ and that no further payment is required.
3. To Activate the Payment Account, the supplier must acknowledge and agree to the payment terms as set by the purchaser.
4. The supplier acknowledges and agrees to the terms, the payment is activated and funds are made available for the payment account.
5. Supplier can present the check for deposit or payment.

Example 7: Current Issue—Investor wants acknowledgement from funds recipient that an investment funds transfer is characterized as separate property, and not community property.

SPP Solution:
1. The investor issues an SPP to the recipient.
2. The investor includes a user Defined Phase with a Security Protocol sufficient for the investor to legally prove that the recipient acknowledged the funds were separate property funds, if acknowledged and agreed to by the recipient.
a. For example: Acceptance of this payment requires recipient to agree that this investment is being made with separate property funds for the sole ownership of the investor as separate property and shall be titled as such.
3. To Activate the Payment Account, the recipient must acknowledge and agree to the payment terms as set by the investor.
4. The recipient acknowledges and agrees to the terms; the payment is activated and funds are made available for the Payment Account.
5. Recipient can present the check for deposit or payment.

Example 8: Current Issue—Users require an on-demand printed paper payment instrument without maintaining pre-printed check stock, while reducing exposure to alteration, counterfeiting, and misappropriation.

SPP Solution: On-demand issuance and printing using a portable printer.
1. A maker accesses the secure payment system using an end-user device and initiates an SPP during an SPP creation phase, including providing, for example, at least a payee identifier and a payment amount.
2. During the SPP issuance phase, the system determines that the SPP is to be issued as a printed paper instrument and assigns one or more security protocols to gate printing (e.g., authentication of the maker, device authentication, and/or confirmation of an authorized printer).
3. Upon successful completion of the assigned security protocols, the end-user device transmits a print job to a portable printer (e.g., a portable thermal printer) over a secure communication channel (e.g., Bluetooth).
4. The portable printer prints the SPP on roll paper. The roll paper can be archival-grade thermal paper and have a roll width to produce a check-like format when printed. The printed SPP can include human-readable fields and one or more machine-readable fields (e.g., a QR code) that reference an SPP identifier.
5. The maker delivers the printed SPP to the payee. In some cases, the payee (or another authorized verifier, such as a bank of first deposit or merchant) uses the machine-readable field to query a verifier interface to determine current SPP validity, activation status, and/or funds-type characterization prior to or at presentment.
6. The maker and/or payee completes any remaining SPP phases according to the security protocols assigned to those phases. For example, the system executes an SPP activate funds transfer phase, in which funds are transferred from an original source of funds account to an SPP payment account, and the system executes an SPP payment account activation phase.
7. After activation, the payee presents the printed SPP for processing using existing clearing mechanisms. In some cases, presentment includes image-based presentment, including mobile deposit capture of the printed instrument. If the presentment is attempted before passing required security protocols, the system can prevent processing of the SPP, and may notify the maker and/or payee of the event.

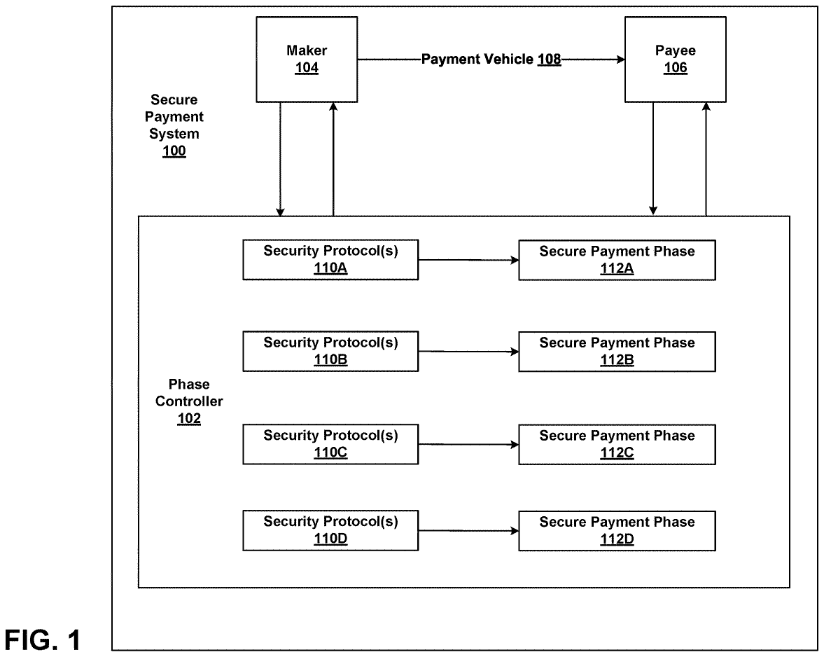

Turning to the illustrations, FIG. 1 shows an example secure payment system 100. The secure payment system 100 is an example of a system implemented as computer programs on one or more computers in one or more locations, in which the systems, components, and techniques described below can be implemented.

The system 100 is a system that facilitates a secure paper payment between a maker 104 and a payee 106. Generally, the maker 104 delivers a payment vehicle 108 (i.e., a physical or digital medium through which a payment is made) to a payee 106. It is not until the system 100 completes execution of the secure paper payment phases 112A-D that the payee 106 will be able to use the payment vehicle 108 to receive payment.

In particular, the system 100 assigns one or more security protocols 110A-D to one or more SPP phases 112A-D.

Next, the system executes a sequence of one or more SPP phases 112A-D using a phase controller 102.

Executing the SPP creation phase 112A includes executing assigned security protocols 110A to access SPP creation and reserving a unique routing-transit number and account number combination for an SPP payment account or creating a unique a unique routing-transit number and account number combination for an SPP payment account, receiving data necessary to create an SPP, and creating an SPP.

Executing the SPP issuance phase 112B includes executing assigned security protocols 110B to access SPP issuance and receiving data to issue an SPP, and issuing the SPP.

Executing the SPP activate funds transfer phase 112C includes executing assigned security protocols 110C to activate funds transfer and executing funds transfer from an original source of funds account to the SPP payment account. It also includes creating unique routing-transit number and account number combinations using the reserved unique routing-transit number and account number combinations for the SPP payment account if the payment account is not already created and, optionally, one or more transfer accounts if the transfer accounts are not already created.

In some implementations, the one or more transfer accounts comprise on-ledger platform ledger accounts or subaccounts identified by internal ledger identifiers and, in some cases, associated with one or more externally addressable settlement accounts for interfacing with external payment or funds transfer systems.

Executing the SPP payment account activation phase 112D includes executing assigned security protocols 110D to access SPP payment account activation and creating a unique routing-transit number and account number combination using the reserved unique routing-transit number and account number combination for the SPP payment account if the account is not already created.

In some implementations, the sequence of one or more SPP phases 112A-D further includes an SPP accord phase. Executing the SPP accord phase includes executing assigned security protocols, presenting a condition to a payee as an offer to resolve a dispute, and receiving acceptance of the condition from the payee.

In some other implementations, the sequence of one or more SPP phases 112A-D further includes SPP create a user-defined-phase phase. Executing the SPP create a user-defined-phase phase includes executing assigned security protocols, executing assigned security protocols, receiving user specified parameters or requirements for one or more user-defined-phases, and creating one or more user-defined-phases. Then executing the user-defined-phases.

After (i) completing the sequence of one or more SPP phases and (ii) satisfying the assigned security protocols to the one or more SPP phases, the system 100 enables the SPP payment so that a payee 106 can use the payment vehicle 108 to receive payment. That is, once the SPP Payment Account has been activated and the SPP has been presented for deposit (by the payee 106), industry standard check processing practices apply.

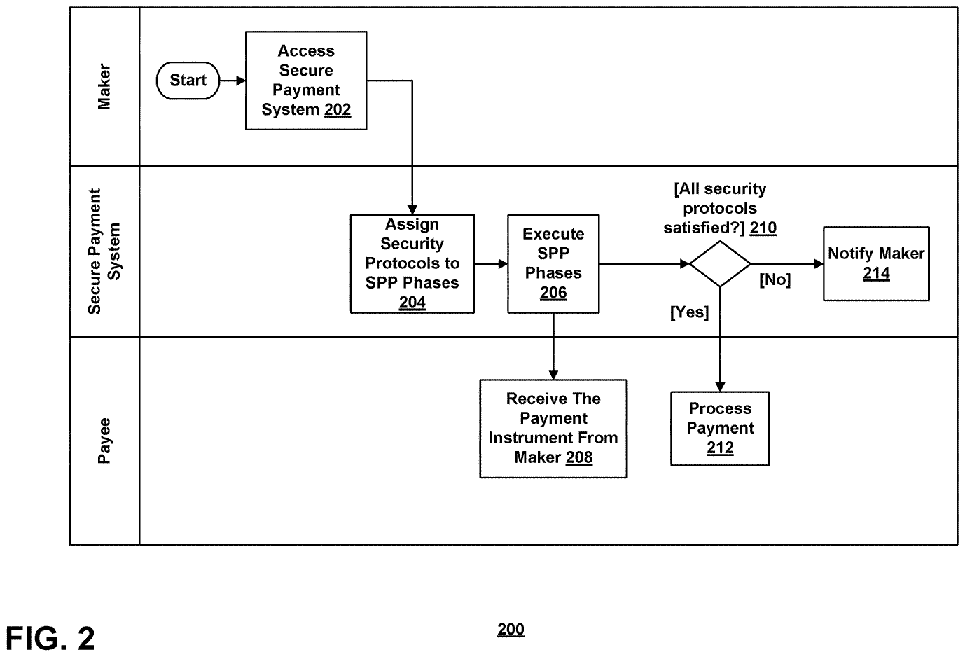

FIG. 2 is a flow diagram of an example process 200 for executing a secure paper payment between a maker and payee. For convenience, the process 200 will be described as being performed by a system of one or more computers located in one or more locations. For example, a secure payment system, e.g., the secure payment system 100 of FIG. 1, appropriately programmed in accordance with this specification, can perform the process 200.

The secure payment system grants the maker access (202). That is, when a maker decides to make a payment to a payee using the secure payment system and accesses the secure payment system in order to do so, the secure payment system executes security protocols and, in response to passing the security protocols, grants the maker access to the secure payment system. In other words, the secure payment system grants access to a maker (e.g., an individual, a business, a government entity, organization, a financial institution, a payment processing system, an employer, an insurance company, a healthcare provider, and so on) initiating access to the secure paper payment system using, e.g., web browser, browser extensions, mobile application, desktop application, cloud services, command line interface, application programming interface (API) calls, and so on, with the intention of delivering payment to a payee (e.g., individuals, businesses, government entities, non-profit organizations, financial institutions, service provides, educational institutions, healthcare providers, landlords, vendors, suppliers, and so on).

As a particular example, the secure payment system grants access to a maker that is an individual initiating access to the secure payment system using a mobile application on a smart phone in order to initiate payment to a payee that is, e.g., another individual, a landlord, a utility company, a retailer, a credit card company, an educational institution, and so on.

As another particular example, the secure payment system grants access to a maker that is a large employer initiating access to the secure payment system using its payment issuing system through API calls in order to initiate payment to a payee that is, e.g., an employee, a vendor, a utility company, a government entity, and so on.

After the system grants the maker accesses to the secure payment system, the secure payment system assigns security protocols to SPP phases (204).

For example, when a user accesses the secure payment system for the first time, the system can register the user and along with assignment of security protocols to SPP phases. For example, a secure payment system can, e.g., through a web application, prompt users to create a login account and to set the account's preferred default assignments of security protocols to SPP phases. The assignment of security protocols can then be updated at any time by a user including before or during execution of the SPP phases (further described below).

As another example, the secure payment system can receive and implement updates to the assigned security protocols from the maker as part of one or more of the SPP phases (described further below). For example, during the SPP creation phase the secure payment system can assign security protocols for proceeding SPP phases just for the payment being created currently or can update default assignments of security protocols to the SPP phases.

In some implementations, the secure payment system's assignment of protocols for various SPP phases may be interdependent with the security protocols and executions of one or more other SPP phase.

For example, during the SPP creation phase, the secure payment system can process the makers inputs for payee identifier, amount of payment, type of funds, payment instrument type, and so on, to determine the security protocol for one or more of the phases that proceed the SPP creation phase.

As another example, the secure payment system's assignment of a security protocol for one SPP phase can trigger automatic security protocol assignment for other SPP phases. For example, if the secure payment system assigns a security protocol of validating a received digital signature to terms and conditions sent to a payee for the SPP account activation phase, the system in response can automatically assign the security protocol to encrypt the sending of the terms and conditions to the SPP issuance phase.

Returning to FIG. 2, the secure payment system executes the SPP phases (206), where all above descriptions of SPP phases apply to the flow diagram being presenting here. Generally, the SPP phases include at least an SPP creation phase (to create the SPP), an SPP issuance phase (to issue the SPP), an SPP activate funds transfer phase (to prepare funds for payment), and an SPP payment account activation phase (to enable payment) and, additionally, the secure payment system executes respective assigned security protocols for each phase before, during, and after executing each phase.

The SPP phases of the system are designed to deliver unparalleled multi-layer security, combined with customization. For example, during the SPP creation phase, the system can generate and reserve a unique random routing and account numbers, which is mandatory for payment processing. However, the system does not necessarily create the payment account itself during the creation phase, but can wait until later, e.g., the SPP payment account activation phase, ensuring that payments cannot be processed without the account's activation. Further enhancing security, the system does not transfer funds into the account until the SPP activate funds transfer phase, preventing the possibility of losing funds even if the routing and account numbers are somehow compromised. And, because the system will never process the payment to the payee from the maker's original source of funds account, the maker's original source of funds account is never exposed. Additionally, the system supports the configuration of a variety of security protocols for each phase and allow users the ability to customizes both the phases and their assigned security protocols. All the features of the SPP phases described here and above make the secure payment system exceptional for at executing secure payments from makers to payees.

In some cases, the security protocols of the SPP phases require an action from the maker, the payee, or both.

As an example of the maker performing an action to satisfy a security protocol, the system can require two-factor authentication from a maker. For example, the system can require the maker to perform SMS verification, (i.e., that the maker enter a code sent to a smart phone via SMS).

As an example of the payee performing an action to satisfy a security protocol, the system can require that the payee agree to terms and conditions. For example, the system can use security protocols such as clickwrap agreements (i.e., the payee must click a checkbox or button stating they agree to the terms and conditions), scrollwrap agreements (i.e., the payee must scroll through a terms and agreement document before accepting an agreement), sign-in wrap agreements (i.e., a payee must sign in or register for a digital account with the secure payment system before agreeing to terms), and so on.

As an example of both the maker and the payee performing an action to satisfy a security protocol, the system can require both the maker and payee provide biometric verification (e.g., fingerprint or facial recognition).

During operation 206, the payee receives the payment instrument from the maker (208).

For example, during the SPP issuance phase the system can print out a physical check that is delivered to the payee.

As another example, during the SPP issuance phase the system can issue an e-check to the payee.

At any point during the payment process, the secure payment system can check that all security protocols of the SPP phases have been satisfied and if ‘yes’, the secure payment system can enable the payee to process the payment (212), else if ‘no’ the secure payment system can notify the maker (214) and, in some implementations, the payee.

For example, as soon as one or more security protocols fail at any time, the system can notify the maker of the failure of the security protocol and any relevant details to the security protocol failure.

As another example, when a payee attempts to process the payment before the completion of all SPP phases, the system can reject the attempt and notify the maker of the attempt.

As another example, when the system completes all SPP phases such that all security protocols have been completed and funds have been transferred to an SPP payment account with a unique account number, the system can enable the payee to process the payment using the information present in the payment instrument.

The combination of these SPP phases results in a unique and secure payment transaction. The system can create the payment instrument and provide it to a person for payment (i.e., the system executes the issuance phase of 206 and facilitates the payee receiving the payment instrument in operation 208) and, if the system detects an attempt to process the payment before the system has activated it (i.e., the system detects the payee attempting to process the payment operation 212), the system prevents the processing of the payment. Only when the system determines that the security protocols' actions/interactions have been performed to satisfaction (i.e., 210 with a ‘yes’ response) will the system make information associated with the payment instrument acceptable or live for processing. Then, in response to a payee attempting to cash/use the payment instrument, the system performs validation/confirmation, and, if valid, the system performs the payment operation (i.e., the system allows the payee to process the payment in operation 212). Otherwise, if the system determines the security actions/interactions have failed, the system notifies relevant parties of the security failure (i.e., operation 214) and does not allow the payment to be processed by the payee at any time (i.e., the system will not allow operation 212 to occur).

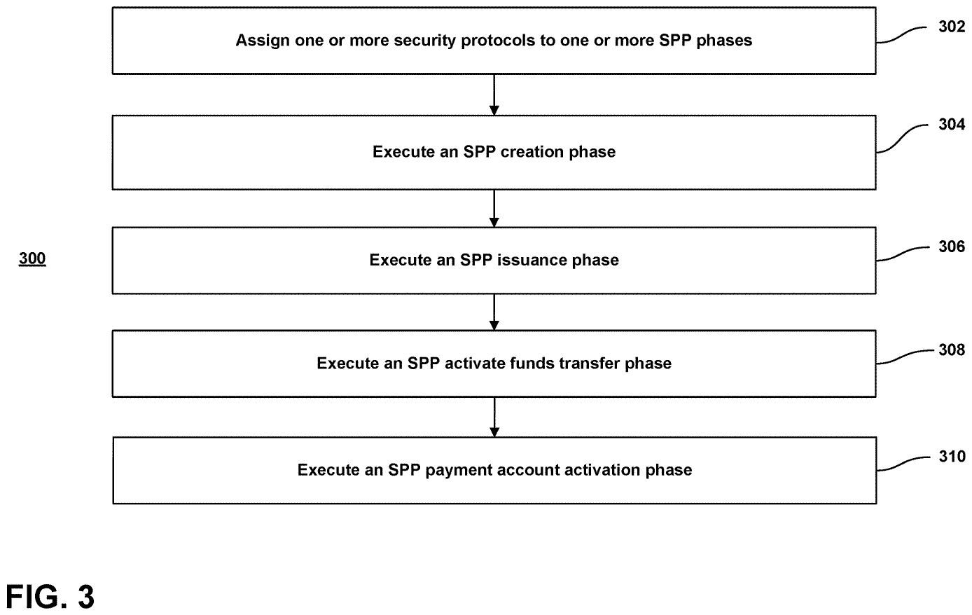

FIG. 3 is a flow diagram of an example process 300 for orchestrating secure paper payment (SPP) phases. For example, the process 300 can be used by the secure payment system 100 of FIG. 1.

The system assigns one or more security protocols to one or more SPP phases (operation 302).

As described above, an SPP phase can be any predefined or user-defined step required to complete an SPP, including, for example, SPP creation, SPP issuance, SPP activate funds transfer, SPP payment account activation, an SPP accord phase, and a user-defined phase; phases may be grouped, re-ordered, executed sequentially or non-sequentially, and can operate independently or interdependently.

A security protocol can include any of a variety of types of security protocols, such as multi-factor or knowledge-based authentication, biometric authentication, device authentication, location/geographic checks, third-party authentication or approvals, data-based authentication, specified date or time-window controls, behavior-based checks, and user-defined protocols, as described above.

In some implementations, when the system assigns the one or more security protocols to one or more SPP phases, the system selects at least one security protocol based on a risk profile associated with at least one of: a user, a device, a transaction, a network, an execution environment, a geographic context, or any combination of these, used to access or execute at least one of the one or more SPP phases.

For example, when the risk profile indicates a low-trust device, the system can require device-native biometric authentication or a second-device out-of-band authentication. As another example, when the risk profile indicates a high-risk user (e.g., a high risk payee), high-risk geographic context (e.g., local regulation requirements of a country), an anomalous network location (e.g., unexpected traffic from a foreign IP range), or atypical transaction (e.g., atypical transaction amount or timing), the system can assign one or more securiety protocols for one or more subsequent SPP phases.

Some examples of the device include, for example, a smartphone, a laptop computer, a desktop computer, or a smartwatch.

Some examples of the risk profile for the device can include, for example, device type, operating system version, and usage metadata.

For example, when the system detects access from a smartphone, it can require smartphone-native biometrics (e.g., facial recognition or fingerprint) as a security protocol, whereas when the system detects access from a laptop computer, it can require a second-device out-of-band factor (e.g., an SMS or app-based approval on the user's phone) before allowing progression to SPP payment account activation.

In some implementations, the system uses a machine-learning model to assign the one or more security protocols to one or more SPP phases. The machine-learning model can be trained to map device and/or SPP transaction features to security protocol sets for the SPP phases.

For example, the system can use a machine-learning model to process one or more SPP transaction features using a machine-learning model configured to evaluate the one or more SPP transaction features and, based on the evaluation, automatically select the one or more security protocols for assignment to the one or more SPP phases.

Device features can include characteristics and signals associated with the accessing device, such as device type (e.g., smartphone, laptop, desktop, smartwatch), operating system and software versions, hardware capabilities (e.g., presence of trusted hardware authenticator), historical usage patterns, and other device metadata.

SPP transaction features can include contextual attributes of the SPP, such as payment amount and variability, timing and frequency of payment requests, geographic or network location indicators, and prior success or failure outcomes of related security protocols.

The machine-learning model can be any of a variety of types of machine learning models, including a neural network, a decision-tree-based model (e.g., gradient-boosted trees), a logistic-regression classifier, or an ensemble that combines multiple models.

As an example, the system collects device features (e.g., smartphone with current OS and hardware-backed biometrics versus a laptop without a trusted hardware authenticator) together with SPP transaction features (e.g., payment value) and inputs those features to the machine-learning model; the model outputs a selected set of security protocols to apply to certain SPP phases. That is, the system can include a machine-learning-based security protocol selector configured to select a security protocol-set identifier for one or more SPP phases. The selector can operate over a fixed feature schema, and a training objective tied to protocol-success and fraud-risk outcomes.

The system then executes the one or more SPP phases. In particular, the system executes an SPP creation phase (operation 304). In the SPP creation phase, the system executes assigned security protocols to the SPP creation phase to access SPP creation, receives data necessary to create an SPP, and creates the SPP.

The data necessary to create an SPP can include, for example, a payee identifier (e.g., name or other payee identifying information), a payment amount, a date, a character of funds (e.g., available funds or good funds), an SPP number, and optional memo or note information.

In some cases, at least one of a routing-transit number, an account number, and a check number for the SPP is randomly generated.

For example, during the SPP creation phase the system can generate and reserve a unique routing-transit number and account number combination (and optionally a randomized check number) for the SPP so that the payment vehicle can be issued without exposing the maker's original account identifiers. The actual SPP payment account can then be created or activated in later phases as the assigned security protocols are satisfied, as will be described in more detail below.

In some cases, in the SPP creation phase, the system reserves one or more unique routing-transit number and account number combinations for respective one or more transfer accounts that move and hold funds between the original source of funds account and the SPP payment account.

That is, the system can pre-allocate (i.e., provision and hold for later use) distinct routing-account identifiers for internal transfer accounts at the time the SPP is being created, even though funds movement and activation may occur in later phases. These reserved identifiers enable the system to stage and route funds through controlled intermediaries rather than directly from the maker's original source account to the SPP payment account, thereby isolating the maker's primary banking credentials and providing fine-grained control over subsequent funds transfers.

Additionally, reserving transfer-account identifiers during creation allows the system to (i) instantiate those transfer accounts when needed in the funds-transfer activation phase, (ii) hold funds under defined holds or characterizations (e.g., available versus good funds) before final activation, and (iii) support workflows in which creation, issuance, funds staging, and activation are separated in time or conditioned on security protocols, while maintaining compatibility with conventional clearing processes once activation is completed.

The system executes an SPP issuance phase (operation 306). In the SPP issuance phase, the system executes assigned security protocols to access SPP issuance, receives data to issue an SPP, and issues the SPP.

Data to issue an SPP can include selections or inputs describing how the SPP is to be issued and delivered, such as: whether issuance will be as a printed paper instrument or as a digital image; the delivery method (e.g., in-person, mail/delivery service, email, text, or another electronic channel); any required co-signers or approvals; selection of the source of funds (e.g., original source of funds, one or more transfer accounts); and definitions of the character and source of funds (e.g., available funds or good funds; maker funds, maker's bank funds, or third-party funds), among others.

In some implementations, the SPP issuance phase requires authenticated approvals from at least two distinct user identities prior to issuing the SPP.

For example, a business or entity may configure issuance so that a preparer enters issuance data and a separate approver (e.g., a manager or controller) authenticates and approves the issuance request. The system can enforce the assigned security protocols for each identity (e.g., MFA, device authentication), and only upon successful completion of both authenticated approvals does the system issue the SPP in the selected format and by the selected delivery method.

In some implementations, issuing the SPP during the SPP issuance phase includes generating a printed paper instrument on demand. For example, issuing the SPP during the SPP issuance phase can include generating a printed paper instrument on demand using a printer communicatively coupled to an end-user device. For example, the end-user device (e.g., a smartphone, tablet, laptop, or desktop computer) can render print data for the SPP and transmit a print job to a printer over a wired or wireless communication channel. Some examples of communication channels can include Bluetooth, Wi-Fi, wired connection, or any combination of these.

In some implementations, the printer includes a portable printer. In some cases, the portable printer includes a thermal printer configured to print on roll paper. In some implementations, the roll paper includes archival-grade thermal paper. In some implementations, a roll width is selected to approximate a check-like format when printed (e.g., an approximately 80 mm roll width can be used to print check-like instrument).

Generally, the printer can be any device configured to generate a physical representation of an SPP on printable medium (e.g., inkjet printer, laser printer, thermal printer, or another printing apparatus). Generally, the printer can also print on any printable media with any width and any format.

In some implementations, the secure payment system formats the printed SPP to include one or more human-readable fields (e.g., payee identifier, amount, date, and an instrument identifier) and one or more machine-readable fields. For example, the printed SPP can include a barcode or QR code encoding referencing an SPP identifier useable to query a verifier interface that belongs to the secure payment system. In some cases, the machine-readable field encodes an identifier that is usable by an authorized verifier (e.g., check Universally Unique Identifier) to obtain SPP validity, activation status, and/or funds-type characterization.

In some implementations, transmission of the print job and/or selection of the printer is gated by one or more security protocols assigned to the SPP issuance phase. For example, prior to transmitting the print job, the system can require multi-factor authentication, device authentication, and/or confirmation that the destination printer is an authorized printer associated with the maker or the maker's end-user device. In some cases, the system maintains logs of SPP printing metadata (e.g., timestamps of events, device identifiers, printer identifiers, geographic context, and so on) in an audit record associated with the SPP.

The system executes an SPP activate funds transfer phase (operation 308). In the SPP activate funds transfer phase, the system executes assigned security protocols to activate funds transfer and executes funds transfer from an original source of funds account to an SPP payment account.

In some cases, when the system reserves one or more unique routing-transit number and account number combinations for respective one or more transfer accounts (e.g., as described above in operation 304), the system creates unique routing-transit number and account number combinations using the reserved unique routing-transit number and account number combinations for the transfer accounts. Then, the system uses the transfer accounts to move and hold funds between the original source of funds account and the SPP payment account.

For example, a maker preparing a vehicle purchase can, during SPP creation, cause the system to reserve a transfer-account identifier. When the purchase date arrives, the system creates the transfer account using the reserved routing-account combination and moves certified “good funds” from the maker's original source of funds account into that transfer account over the weekend. The funds remain held there until the SPP payment account is activated at the dealership, after which the system transfers the held funds from the transfer account into the SPP payment account for presentment through conventional clearing.

In another example, a business issuing milestone-based payments to a contractor has the system reserve three transfer-account identifiers at SPP creation (one per milestone). Upon each milestone's third-party approval (per assigned security protocols), the system instantiates the corresponding transfer account, moves the milestone's funds from the original source of funds account into that transfer account, and holds the funds with the designated characterization (e.g., “good funds”) until the related SPP payment account is activated, after which the funds are released from the transfer account to the SPP payment account for deposit by the contractor.

As a further example, for government disbursements (e.g., refunds), the issuing entity can direct the system, at SPP creation, to reserve transfer-account identifiers tied to recipient-specific protocols. When the recipient passes required identity or knowledge-based checks, the system creates the reserved transfer account, moves the disbursement into that account, and maintains a hold until the SPP payment account is activated. Once activated, the system routes the funds from the transfer account into the SPP payment account for processing through existing check-clearing networks.

The system executes an SPP payment account activation phase (operation 310). In the SPP payment account activation phase, the system executes assigned security protocols to access SPP payment account activation.

In some implementations, the system can detect access from a first device lacking a trusted hardware authenticator and, in response, requires a second-device out-of-band authentication prior to the SPP payment account activation phase.

For example, a user can open a web portal on a laptop that lacks a trusted platform module. The system detects the absence of a hardware authenticator and blocks advancement to the SPP payment account activation phase until the user confirms a push notification on their registered smartphone (i.e., a second device with hardware-backed credentials). Only after that second-device approval does the system proceed to execute the SPP payment account activation phase.

In some implementations, the SPP payment account is created prior to activation and remains non-operational until all activation-phase security protocols succeed.

For example, during earlier phases the system may create the SPP payment account (e.g., when funds are staged) but keep it in a non-active state; if the payee later passes identity verification and any required third-party approvals, the system then changes the state of that already-created account to active so that standard check-processing practices can proceed.

In some other implementations, the SPP payment account is created at the time of activation. For example, the account identifiers are reserved at creation and the actual account record is instantiated simultaneously with satisfying the activation-phase security protocols so that creation and activation occur together.

In some cases, at least one security protocol executed in at least one SPP phase causes a change in funds availability type of at least one of the original source of funds account, one or more transfer accounts, the SPP payment account, or any combination of these accounts.

As described above, funds availability types include, for example, available funds, good funds, certified maker funds, certified bank funds, and the system can dynamically change the funds availability type in response to security protocol outcomes.

For example, after issuance but before activation, the maker may require a payee to complete specified verification; upon successful completion, a protocol changes the characterization of funds for the SPP payment account from “available” to “good funds,” enabling immediate availability on deposit.

In some implementations, in the SPP payment account activation phase, the system initiates a persistent security measure enforcing that post-activation debits to the SPP payment account are authorized only in an amount exactly equal to a stored SPP amount of the SPP.

For example, when activation completes, the system enables an “exact-amount-only” rule so that any attempted debit that differs from the SPP's stored amount is automatically blocked by the system, even though the account is active and funded.

The order of operations in the process 300 described above is illustrative only and can be performed in different orders, including sequentially, concurrently, in parallel, and/or asynchronously. For example, the SPP issuance phase and the SPP activate funds-transfer phase can be executed in parallel while awaiting completion of prerequisites for the SPP payment account activation phase.

In some implementations, the process 300 can include additional operations, fewer operations, or some of the operations can be divided into multiple operations.

In some implementations, the sequence of one or more SPP phases includes an SPP accord phase. The system, in the SPP accord phase, executes the assigned security protocols to the SPP accord phase, presents a condition to a payee as an offer to resolve a dispute, and receives acceptance of the condition from the payee.

In some cases, the SPP accord phase requires validation of a digital signature over the accord terms before funds transfer activation proceeds.

As an example, a purchaser discovers that 10% of delivered goods are defective and proposes to settle by paying for the non-defective portion only. During the SPP accord phase, the system (i) enforces the phase's assigned security protocols to authenticate the parties, (ii) presents accord terms stating that the payment constitutes full satisfaction of the original purchase obligation, and (iii) receives the payee's acceptance of those terms. In some cases, the system requires the payee to apply a validated digital signature to the accord document; only upon successful signature validation does the system permit progression to funds-transfer activation and, subsequently, to SPP payment account activation.

In some implementations, the sequence of one or more SPP phases includes an SPP user-defined-phase-creation phase. The system, in the SPP user-defined-phase-creation phase, executes assigned security protocols, receives user-specified parameters or requirements for one or more user-defined phases and creates one or more user-defined phases, and executes the user-defined phases.

As an example, the system first authenticates the maker (or another authorized user) under the security protocols assigned to the user-defined-phase-creation phase and then accepts structured parameters that define the behavior of new SPP phases. Once created, these user-defined phases are inserted into the SPP sequence and are enforced like predefined SPP phases, including being gated by their own assigned security protocols.

In some cases, at least one of the one or more user-defined phases includes obtaining a cryptographically authenticated approval from a third-party to enable the SPP payment account activation phase.

Some examples of the third-party entity include inspector, escrow agent, or transfer agent.

As an example, a construction payment SPP can include a user-defined SPP phase that requires a licensed inspector to review work and submit an authenticated approval. The system enforces the user-defined SPP phase's security protocols, receives the inspector's approval with a validated digital signature, records the approval as satisfying the user-defined SPP phase, and only then allows progression to the SPP payment account activation phase. If the approval is not received or fails validation, the SPP activation phase remains unavailable and funds remain held under the previously defined characterization.

In some implementations, at any point during operations 302-310, the system provides, to a verifier, an interface that returns or presents current SPP validity, activation status, and funds-type characterization in response to verifier credentials.

The interface can be a programmatic computer interface, such as an API or other web-service endpoint for institution systems, a secure web portal accessed via browser, a mobile application UI, a teller/workstation application integrated with bank terminals, or an automated batch/upload interface that accepts file-based requests and returns machine-readable responses (e.g., JSON, XML), as well as other suitable options.

For example, a bank of first deposit or a teller, after authenticating to the system, can query the system and receive a response indicating whether the SPP is valid, whether the SPP payment account is active, and whether funds are available or classified as good funds, enabling informed handling of the instrument prior to or at presentment.

In some implementations, failure in a first security protocol triggers assignment of an enhanced second set of security protocols for at least one subsequent SPP phase.

For example, if a payee fails a security protocol that includes identity verification during the SPP issuance phase, the system can automatically augment the security protocols required for the SPP payment account activation phase to include additional security protocols, such as device-based biometric authentication and a second-device out-of-band approval before activation can proceed.

In some implementations, the system, upon satisfaction of all the assigned one or more security protocols to the one or more SPP phases, authorizes a debit from the SPP payment account and a corresponding credit to a payee account via a payment processing system.

The payment processing system can include, for example, wire systems, instant payment rails, card networks, blockchain/cryptocurrency settlement networks, etc.

In some implementations, in response to a failure of at least one of the assigned security protocols in any SPP phase, the system cancels the SPP and prevents processing of the SPP through a payment processing system.

For example, if a security protocol that requires third-party approval (e.g., an inspector's authenticated sign-off) is not received or fails validation prior to the SPP payment account activation phase, the system can mark the SPP as canceled, maintain or release any staged funds according to the configured protocols, and reject any attempted presentment so that no processing occurs in the check-clearing or ACH conversion networks.

Embodiments of the subject matter and the operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the different functions can be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing models described in this specification can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any disclosure or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claim in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
assigning one or more security protocols to one or more secure paper payment (SPP) phases;
executing the one or more SPP phases, comprising:
executing an SPP creation phase, wherein the SPP creation phase comprises executing assigned security protocols to access SPP creation, receiving data necessary to create an SPP, and creating the SPP;
executing an SPP issuance phase, wherein the SPP issuance phase comprises executing assigned security protocols to access SPP issuance, receiving data to issue an SPP, and issuing the SPP;
executing an SPP activate funds transfer phase, wherein the SPP activate funds transfer phase comprises executing assigned security protocols to activate funds transfer and executing funds transfer from an original source of funds account to an SPP payment account; and
executing an SPP payment account activation phase, wherein the SPP payment account activation phase comprises executing assigned security protocols to access SPP payment account activation.

2. The method of claim 1,
wherein executing the SPP creation phase further comprises:
reserving one or more unique routing-transit number and account number combinations for respective one or more transfer accounts that move and hold funds between the original source of funds account and the SPP payment account; and
wherein executing funds transfer from the original source of funds account to the SPP payment account comprises:
creating unique routing-transit number and account number combinations using the reserved unique routing-transit number and account number combinations for the transfer accounts; and
using the transfer accounts to move and hold funds between the original source of funds account and the SPP payment account.

3. The method of claim 1, wherein executing the sequence of one or more SPP phases further comprises:
executing an SPP accord phase, wherein the SPP accord phase comprises:
executing assigned security protocols;
presenting a condition to a payee as an offer to resolve a dispute; and
receiving acceptance of the condition from the payee.

4. The method of claim 3, wherein the SPP accord phase requires validation of a digital signature over the accord terms before funds transfer activation proceeds.

5. The method of claim 1, wherein executing the sequence of one or more SPP phases further comprises:
executing an SPP user-defined-phase-creation phase, wherein the SPP user-defined-phase-creation comprises:
executing assigned security protocols;
receiving user-specified parameters or requirements for one or more user-defined phases; and
creating one or more user-defined phases; and
executing the user-defined phases.

6. The method of claim 5, wherein at least one of the one or more user-defined phases comprises obtaining a cryptographically authenticated approval from a third-party entity to enable the SPP payment account activation phase.

7. The method of claim 1, wherein at least one security protocol executed in at least one SPP phase causes a change in funds availability type of at least one of the original source of funds account, one or more transfer accounts, the SPP payment account, or any combination of these accounts.

8. The method of claim 1, wherein assigning the one or more security protocols to one or more SPP phases comprises selecting at least one security protocol based on a risk profile associated with at least one of: a user, a device, a transaction, a network, an execution environment, a geographic context, or any combination of these, used to access or execute at least one of the one or more SPP phases.

9. The method of claim 1, wherein in response to detecting access from a first device lacking a trusted hardware authenticator, assigning the one or more security protocols to one or more SPP phases comprises requiring a second-device out-of-band authentication prior to the SPP payment account activation phase.

10. The method of claim 1, wherein assigning the one or more security protocols to the one or more SPP phases comprises processing one or more SPP transaction features using a machine-learning model configured to evaluate the one or more SPP transaction features and, based on the evaluation, automatically select the one or more security protocols for assignment to the one or more SPP phases.

11. The method of claim 1, wherein the SPP payment account activation phase comprises initiating a persistent security measure enforcing that post-activation debits to the SPP payment account are authorized only in an amount exactly equal to a stored SPP amount of the SPP.

12. The method of claim 1, wherein at least one of a routing-transit number, an account number, and a check number for the SPP is randomly generated.

13. The method of claim 1, wherein the SPP payment account is created prior to activation and remains non-operational until all activation-phase security protocols succeed.

14. The method of claim 1, wherein the SPP issuance phase requires authenticated approvals from at least two distinct user identities prior to issuing the SPP.

15. The method of claim 1, further comprising:
providing, to a verifier, an interface that returns current SPP validity, activation status, and funds-type characterization in response to verifier credentials.

16. The method of claim 1, wherein failure in a first security protocol triggers assignment of an enhanced second set of security protocols for at least one subsequent SPP phase.

17. The method of claim 1, further comprising:
authorizing, upon satisfaction of all the assigned one or more security protocols to the one or more SPP phases, a debit from the SPP payment account and a corresponding credit to a payee account via a payment processing system.

18. The method of claim 1, further comprising:
in response to a failure of at least one of the assigned security protocols in any SPP phase, canceling the SPP and preventing processing of the SPP through a payment processing system.

19. A system comprising:
one or more computers; and
one or more storage devices communicatively coupled to the one or more computers, wherein the one or more storage devices store instructions that, when executed by the one or more computers, cause the one or more computers to perform operations, the operations comprising:
assigning one or more security protocols to one or more SPP phases;
executing the one or more SPP phases, comprising:
executing an SPP creation phase, wherein the SPP creation phase comprises executing assigned security protocols to access SPP creation, receiving data necessary to create an SPP, and creating the SPP;
executing an SPP issuance phase, wherein the SPP issuance phase comprises executing assigned security protocols to access SPP issuance, receiving data to issue an SPP, and issuing the SPP;
executing an SPP activate funds transfer phase, wherein the SPP activate funds transfer phase comprises executing assigned security protocols to activate funds transfer and executing funds transfer from an original source of funds account to an SPP payment account; and
executing an SPP payment account activation phase, wherein the SPP payment account activation phase comprises executing assigned security protocols to access SPP payment account activation.

20. One or more non-transitory computer storage media storing instructions that when executed by one or more computers cause the one or more computers to perform operations, the operations comprising:
assigning one or more security protocols to one or more SPP phases;
executing the one or more SPP phases comprising:
executing an SPP creation phase, wherein the SPP creation phase comprises executing assigned security protocols to access SPP creation, receiving data necessary to create an SPP, and creating the SPP;
executing an SPP issuance phase, wherein the SPP issuance phase comprises executing assigned security protocols to access SPP issuance, receiving data to issue an SPP, and issuing the SPP;
executing an SPP activate funds transfer phase, wherein the SPP activate funds transfer phase comprises executing assigned security protocols to activate funds transfer and executing funds transfer from an original source of funds account to an SPP payment account; and
executing an SPP payment account activation phase, wherein the SPP payment account activation phase comprises executing assigned security protocols to access SPP payment account activation.
